(19) United States
(12) Patent Application Publication
(10) Pub. No.: US 2026/0299676 A1
(43) Pub. Date: Oct. 1, 2026

(54) A METHOD, A COMPUTER PROGRAM AND AN APPARATUS FOR ADJUSTING A SERVICE CONSUMED BY A HUMAN, A ROBOT, A VEHICLE, AN ENTERTAINMENT SYSTEM, AND A SMART HOME SYSTEM

(71) Applicant: Sony Group Corporation, Tokyo (JP)

(72) Inventors: Shan LIN, Stuttgart (DE); Piergiorgio SARTOR, Stuttgart (DE); Diederik Paul MOEYS, Stuttgart (DE)

(73) Assignee: Sony Group Corporation, Tokyo (JP)

(21) Appl. No.: 19/163,387

(22) PCT Filed: Mar. 15, 2024
(86) PCT No.: PCT/EP2024/057058

§ 371 Date: Sep. 9, 2025

(30) Foreign Application Priority Data
Mar. 21, 2023 (EP) 23163120.1

(51) Int. Cl. G06F 3/01; G06V 40/16; G06V 40/20

(52) U.S. Cl. CPC G06F 3/011; G06V 40/174; G06V 40/20

(57) ABSTRACT

Examples relate to a method, a computer program, and an apparatus for adjusting a service consumed by a human, a robot, a vehicle, an entertainment system and a smart home system. The method for adjusting a service consumed by a human comprises capturing optical event data of the human using an event-based sensor and analyzing the optical event data to detect predefined emotional patterns. The method further comprises determining information on an emotional state of the human based on detected emotional patterns in the optical event data and adjusting the service based on the information on the emotional state of the human.

### FIELD

Examples relate to a method, a computer program, and an apparatus for adjusting a service consumed by a human, a robot, a vehicle, an entertainment system and a smart home system, more specifically, but not exclusively, to a concept for adjusting a service consumed by a human based on an emotional state of the human.

### BACKGROUND

Conventionally, human emotion recognition is a challenging task since it is difficult to reveal one's inner emotions. However, through the mimic on the face, as well as body language, it would be possible to conduct a human emotion analysis. For example, in our daily communication human emotions are expressed mainly through facial expressions. Facial expressions are complex as they are based on a multiplicity of factors and contributors. Nevertheless, models are known, which map a certain human emotion to a certain facial expression. For example, it is well known that laughing or smiling is an expression for happiness and that the corners of one's mouth are lifted when laughing or smiling.

### SUMMARY

Examples are based on the finding that an event-based optical sensor can be used to capture micro movements in a face of a human. Based on the optical event data that comprises information on the micro movements an emotional state of the human can be detected on the basis of predefined emotional patterns. Services can then be adapted or adjusted based on the emotional state of the human.

Examples provide a method for adjusting a service consumed by a human. The method comprises capturing optical event data of the human using an event-based sensor and analyzing the optical event data to detect predefined emotional patterns. The method further comprises determining information on an emotional state of the human based on detected emotional patterns in the optical event data and adjusting the service based on the information on the emotional state of the human. Compared to conventional video data the event-based optical data may comprise a higher frame rate or resolution, so shorter movements can be detected and considered for the determination of the emotional state.

For example, the service is a game, a movie, a smart home service, or a metaverse. As the following description will show, there is a large variety of services that may benefit from adjustments based on the emotional state of a human. Furthermore, the capturing may comprise capturing optical event data from a plurality of event-based sensors. Using event-data from multiple sensors may contribute to a resolution of the data and more reliable detection of emotional patterns. In some examples, the capturing may comprise capturing optical event data in 3-dimensional (3D) volume comprising a time component. Therewith, an even more detailed analysis of the predefined patterns may be enabled, e.g. using 3D data over time.

Depending on specific implementations in examples, the optical event data may comprise pixelwise polarity data on brightness, color or contrast changes. The sampling of changes in the optical quantity allows a reduction in data rate, while still maintaining a high frame or sampling rate. Communicating only differential data, e.g. changes in polarity, brightness, and/or color, allows a reduction of the data amount that is communicated. For example, the optical event data has a sampling rate of at least 500 frames per second. Therewith, even very short optical changes can be tracked. The analyzing might comprise determining micro movements in the optical event data to detect the predefined emotional patterns. For example, the micro movements refer to one or more elements of the group of the human's mouth, eye, eyebrow, eye lid, lip, jaw, skin, cheek and nose. Examples may enable tracking or acquisition of optical event data on micro movements, which allow a detailed analysis, for example, of facial expressions of the human. The analyzing may hence comprise analyzing a facial expression of the human to detect the emotional state. As the facial expression might not be the only indicator for an emotional state the analyzing may also comprise analyzing a body posture or gesture of the human to detect the emotional state.

As has been outlined before basically any conceivable service may be adjusted based on the emotional state in examples. The adjusting of the service might comprise one or more elements of the group of increasing or decreasing an agility of a gaming character, increasing or decreasing a volume of audio, increasing or decreasing a speed of speech or audio content, changing a style of music, adjusting a room temperature, adjusting a brightness and/or color of lighting, offering special effects in the service, adjusting of an avatar of the human, and/or introducing other humans to the human. The service may be provided in any environment, examples are smart home, car, virtual or augmented reality, entertainment, etc.

Examples also provide a computer program having a program code for performing a method as described herein, when the computer program is executed on a computer, a processor, or a programmable hardware component. Another example is an apparatus for adjusting a service consumed by a human, the apparatus comprising circuitry configured to perform any of the methods described herein. For example, the apparatus further comprises a plurality of event-based optical sensors with different field of views of the user.

Further examples are a robot comprising the apparatus, a vehicle comprising the apparatus, an entertainment system comprising the apparatus, and/or a smart home system comprising the apparatus.

### BRIEF DESCRIPTION OF THE FIGURES

Some examples of apparatuses and/or methods will be described in the following by way of example only, and with reference to the accompanying figures, in which

FIG. 1 shows a block diagram of a flow chart of an example of a method for adjusting a service consumed by a human;

FIG. 2 shows a block diagram of an example of an apparatus for adjusting a service consumed by a human;

FIG. 3 illustrates examples of discrete emotional models;

FIG. 4 illustrates examples of dimensional emotion models;

FIG. 5 depicts examples of face expressions;

FIG. 6 illustrates a block diagram of a method for detecting an emotional state of a human in an example;

FIG. 7 shows a block diagram of another example of a method for adjusting a service for a human based on the emotional state of the human;

FIG. 8 illustrates detection of an emotional state based on predefined patterns;

FIG. 9 shows a block diagram of another example of a method for adjusting a service (gaming/film or metaverse) for a human based on the emotional state of the human;

FIG. 10 shows a block diagram of the example of FIG. 9 with additional information;

FIG. 11 shows a block diagram of another example of a method for adjusting a robot service for a human based on the emotional state of the human; and

FIG. 12 shows a block diagram of the example method of FIG. 11 with additional information.

### DETAILED DESCRIPTION

Some examples are now described in more detail with reference to the enclosed figures. However, other possible examples are not limited to the features of these examples described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

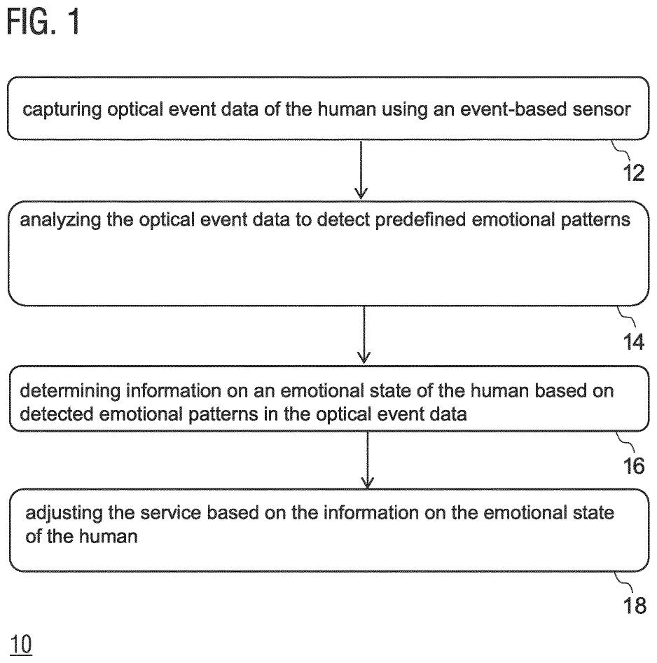

FIG. 1 shows a block diagram of a flow chart of an example of a method 10 for adjusting a service consumed by a human. The method 10 comprises capturing 12 optical event data of the human using an event-based sensor and analyzing 14 the optical event data to detect predefined emotional patterns. The method 10 further comprises determining 16 information on an emotional state of the human based on detected emotional patterns in the optical event data and adjusting 18 the service based on the information on the emotional state of the human.

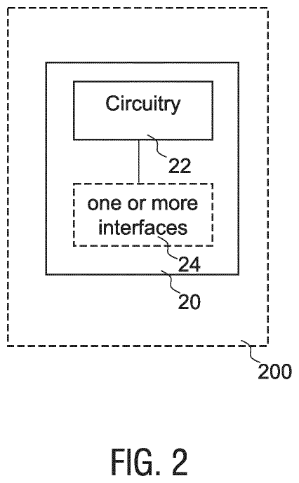

FIG. 2 shows a block diagram of an example of an apparatus 20 for adjusting a service consumed by a human. The apparatus 20 comprises circuitry 22, which is configured to perform the method 10 or any method described herein. FIG. 2 further illustrates an optional entity 200, which comprises the apparatus 20. For example, the entity 200 may be a robot (industrial or home), a vehicle (car, bus truck, train, plane, etc.), an entertainment system (home, inflight, in-vehicle, etc.), or a smart home system (light control, temperature control etc.).

The circuitry 22 may be implemented using one or more processing units, one or more processing devices, any means for processing, such as a processor, a computer or a programmable hardware component being operable with accordingly adapted software. In other words, the described function of the circuitry 22 may as well be implemented in software, which is then executed on one or more programmable hardware components. Such hardware components may comprise a general-purpose processor, a Digital Signal Processor (DSP), a Graphics Processing Unit (GPU), a micro-controller, etc. A further example is a device or entity 200, e.g. an automated system, e.g. for entertainment, gaming, exercising, vehicle, comprising an example of the apparatus 20.

As further illustrated in FIG. 2, the apparatus 20 may optionally (shown in broken lines) comprise one or more interfaces 24, which are coupled to the respective circuitry 22. The one or more interfaces 24 may correspond to one or more inputs and/or outputs for receiving and/or transmitting information, which may be in digital (bit) values according to a specified code, within a module, between modules or between modules of different entities. For example, an interface 24 may comprise interface circuitry configured to receive and/or transmit information. In examples an interface 24 may correspond to any means for obtaining, receiving, transmitting or providing analog or digital signals or information, e.g. any connector, contact, pin, register, input port, output port, conductor, lane, etc., which allows providing or obtaining a signal or information. An interface 24 may be configured to communicate (transmit, receive, or both) in a wireless or wireline manner and it may be configured to communicate, i.e. transmit and/or receive signals, information with further internal or external components. The one or more interfaces 24 may comprise further components to enable communication in a (mobile) communication system, such components may include transceiver (transmitter and/or receiver) components, such as one or more Low-Noise Amplifiers (LNAs), one or more Power-Amplifiers (PAS), one or more duplexers, one or more diplexers, one or more filters or filter circuitry, one or more converters, one or more mixers, accordingly, adapted radio frequency components, etc. The interface 24 may be used to provide service adjustment information to a device offering the service to a user or human.

Human emotion recognition is a challenging task since it is difficult to reveal one's inner emotions. However, through the mimic on the face, as well as body language, it would be possible to conduct a human emotion analysis. A study revealed, in our daily communication, that human emotions are expressed mainly through facial expressions (55%), cf. A. Mehrabian, Communicating Without Words, Psychol. Today. (1968) 53-55. Normal cameras might not be sufficient to capture facial micro-expressions, which can be enabled using event-based vision (EVS) sensors. An EVS sensor can detect sudden changes of expression, like eyebrow movements, gulping, pulsating veins or sudden eye motions, e.g., when people are lying, they tend to look down, when they are recalling, they tend to look up. Human facial changes and movements are difficult for conventional cameras to detect due to their speed and low contrast. Moreover, frame-based data may have high redundancy on the acquired data for emotion analysis. Image-wise camera sensing may cause large data storage and processing delays. Conventional cameras may struggle to capture facial microexpressions, which occur in short amounts of time, and high costs may result when using high-speed cameras.

Examples make use of one or more event sensors. An event camera is an imaging sensor that responds to local changes, e.g. in brightness. Event cameras do not capture images using a shutter as conventional (frame) cameras do. Instead, each pixel inside an event camera operates independently and asynchronously, reporting changes in brightness as they occur, and staying silent otherwise. Event cameras have been seen as the next generation for computer vision tasks, because of their high speed, high dynamic range as well as the efficiency of data acquisition. Event cameras are used to capture the movement in the scene, and static objects will not activate the event sensor.

In further examples, the apparatus 20 may further comprise one or more, e.g. a plurality of, event-based optical sensors, which may have different field of views of the user. The one or more sensors may be used for capturing 12 the optical event data of the human. For example, a sensor may comprise pixelwise sensors, which operate independently and asynchronously. The pixel-sensors may activate upon change detection, i.e. if optical properties captured by that pixel change, e.g. when a movement or an event occurs. The optical event data may comprise pixelwise polarity data on brightness, color and/or contrast changes.

This may allow for lower latencies, lower power consumption and lower data processing requirements as compared to frame-based sensors, which capture information on a full frame in each sampling step. An event-based sensor may have a higher dynamic range than frame-based sensors, even if they use high-speed vision (high frame rates). For example, the optical event data has a sampling rate of at least 500 frames per second. Using event-based sensors, events may be recorded that would otherwise require conventional cameras to run at 10.000 images/second and more. Event-based sensors may allow latencies at 40-200 us at high bandwidths, e.g. 60 Meps (Megaevents per second) and more. Moreover, even 3D capturing may be enabled by event-based sensors. The capturing 12 may comprise capturing optical event data in 3D volume, comprising a time component, which may form a data basis for very efficient and precise movement detection.

Emotion recognition and sentiment analysis with an event-based vision sensor (facial/body) may enable real-time or close to real-time adjustment, 1-10 ms algorithmic adjustments. For example, a high-speed camera may operate at 100 frames/s, while an event-based sensor may operate at 1.000 frames/s (events/s) and more.

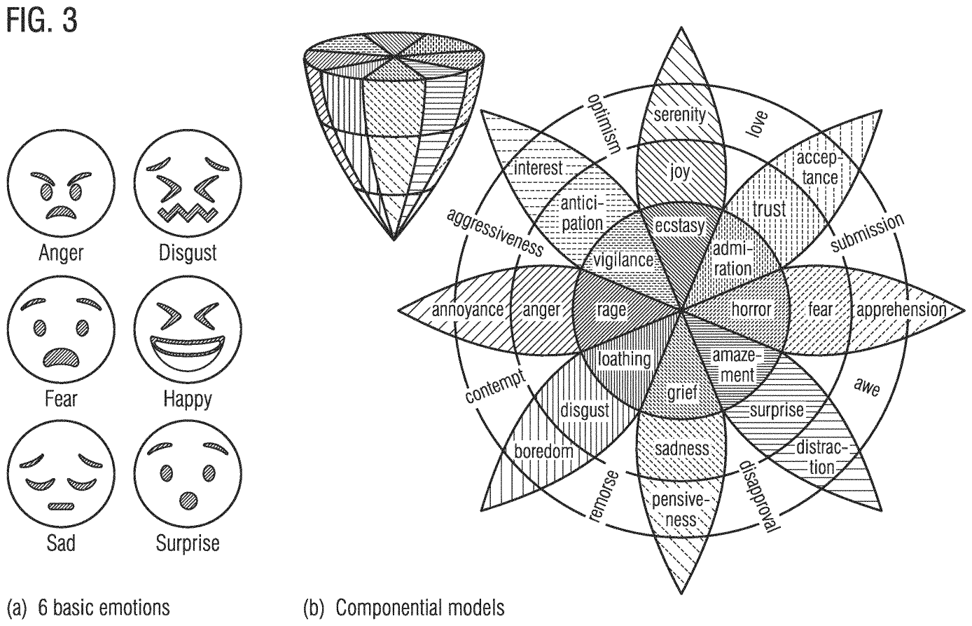

In examples, emotional models may be used to map predefined emotional patterns to an emotional state of the human. FIG. 3 illustrates examples of discrete emotional models. Two discrete emotion models for affective computing are shown. FIG. 3(a) on the left shows six basic emotions (anger, disgust, fear, happy, sad, and surprise) illustrated as emoji types. FIG. 3(b) on the right illustrates a more advanced emotional wheel model, which has a finer distinction of different emotions. Discrete emotion models define emotions into limited categories, the two widely used emotion models are Ekman's six basic emotions (anger, disgust, fear, happy, sad, surprise), cf. P. Ekman, Universals and cultural differences in facial expressions of emotion, Nebr. Symp. Motiv. 19 (1971) 207-283, and Plutchik's emotional wheel model, Plutchik Robert, Emotion and Life: perspective from psychology biology and evolution, Am. Physiol. Assoc. (2003), both of which are shown in FIG. 3.

The development of Ekman's basic emotion model is based on the hypothesis that human emotions are shared across races and cultures, cf. Wang Y, Song W, Tao W, et al. A systematic review on affective computing: Emotion models, databases, and recent advances, Information Fusion, 2022. From the emojis, one can recognize the differences on the facial expression for different emotions.

Different from Ekman's basic emotion model, Plutchik's emotional wheel model involves eight emotions (joy, fear, surprise, sadness, anticipation, anger, and disgust) and the relation between one emotion to one another.

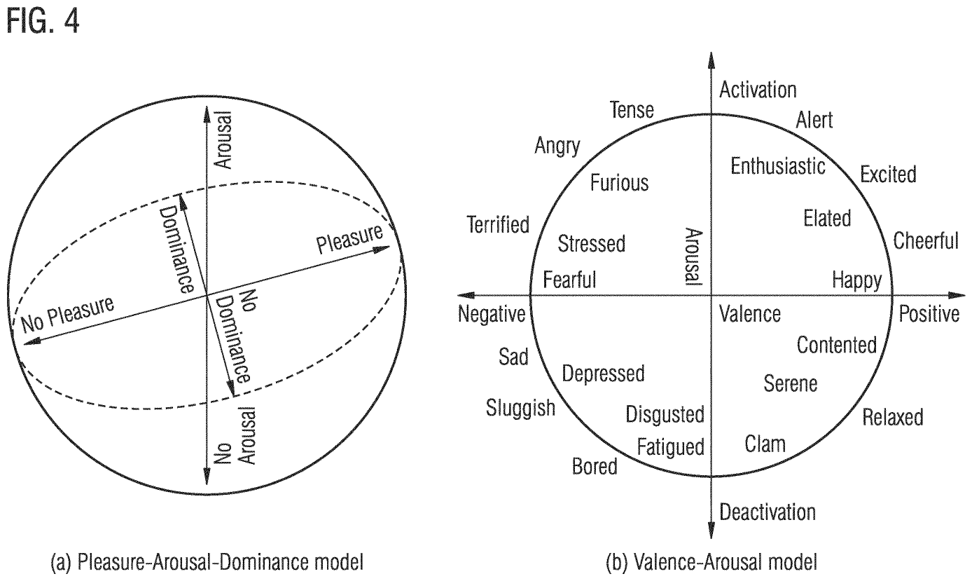

FIG. 4 illustrates examples of dimensional emotion models. A continuous multi-dimensional model is introduced to describe fine-grained sentiments. As shown in FIG. 4, two of the most recognized models are Pleasure-Arousal-Dominance (PAD) model (FIG. 4(a) on the left) and Valence-Arousal (V-A) model (FIG. 4(a) on the right). A two-dimensional PAD model can represent most of the different emotions and the V-A model is used to represent complex emotions.

Examples may consider facial expressions and emotions. With the different movement and indications on our face, humans are communicating their emotion and feeling with others, as the following examples will show, https://www.scienceofpeople.com/microexpressions/.

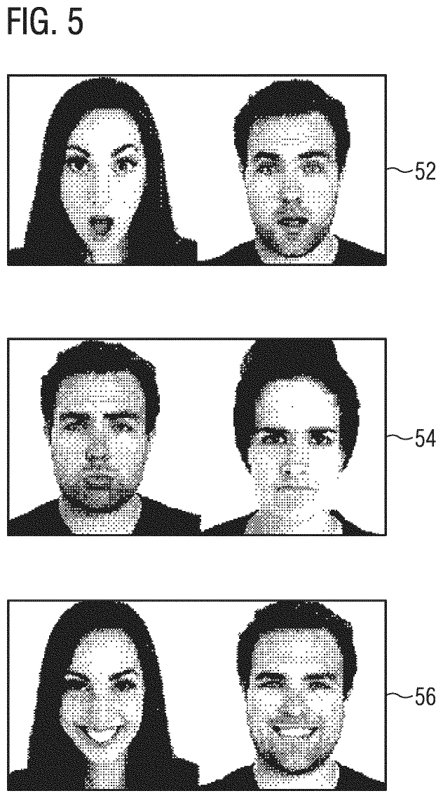

FIG. 5 depicts examples of face expressions. FIG. 5 depicts pairs of female and male facial expressions for surprise 52 at the top, sadness 54 in the middle, and happiness 56 at the bottom.

For the facial expression of surprise 52 the following facial movements (emotional patterns) contribute to the expression of surprise feeling:
The eyebrows are raised and curved,
Skin below the brow is stretched,
Horizontal wrinkles show across the forehead,
Eyelids are opened, white of the eye showing above and below, and
Jaw drops open and teeth are parted but there is no tension or stretching of the mouth.

For the facial expression of sadness 54 the following facial movements (emotional patterns) contribute to the expression of sadness feeling:
Inner corners of the eyebrows are drawn in and then up,
Skin below the eyebrows is triangulated, with inner corner up,
Corners of the lips are drawn down,
Jaw comes up, and
Lower lip pouts out.

For the facial expression of happiness 56 the following facial movements (emotional patterns) contribute to the expression of happiness feeling:
Corners of the lips are drawn back and up,
Mouth may or might not be parted, teeth exposed,
A wrinkle runs from outer nose to outer lip,
Cheeks are raised,
Lower eyelid may show wrinkles or be tense, and
Crow's feet near the outside of the eyes.

Examples may determine micro movements in the optical event data to detect the predefined emotional patterns as part of the above analyzing 14 step. The micro movements may refer to one or more elements of the group of the human's mouth, eye, eyebrow, eye lid, lip, jaw, skin, cheek and nose. As outlined above and indicated by the facial expression in FIG. 5, the analyzing 14 may comprise analyzing a facial expression of the human to detect the emotional state. In further examples the analyzing 14 may additionally comprise analyzing a body posture or gesture of the human to detect the emotional state.

As mentioned above, facial expressions can be used as a reliable feature for analyzing human emotion, since human tend to make similar facial expression when they feel similar emotion. Therefore, with the changing on human face, it would be possible to analyze the emotion of the person according to the typical facial expression pattern. Event cameras can be used to capture the movements as well as changes on face in an effective way, in particular facial micro-expressions may be captured. Compared with the conventual RGB (Red, Green, Blue) cameras, event cameras have higher frame rate to capture the micro-expression which can occur as fast as 1/15 to 1/25 of a second.

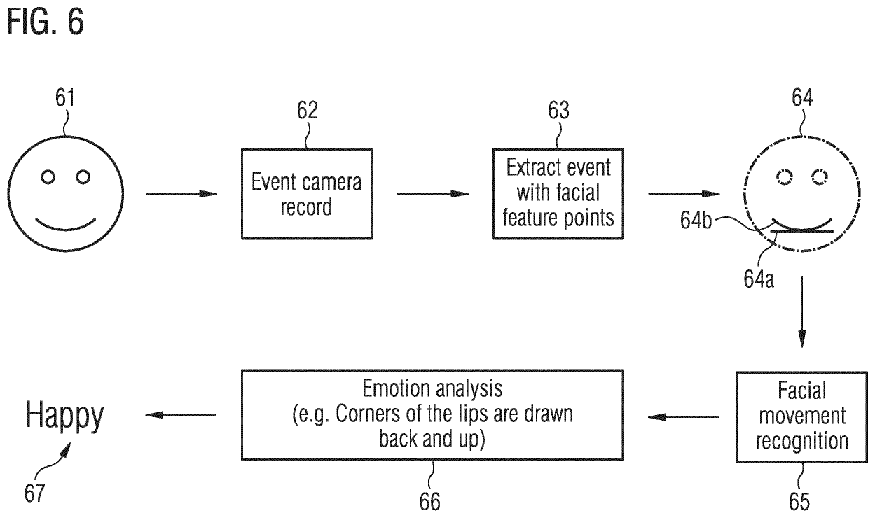

FIG. 6 illustrates a block diagram of a method for detecting an emotional state of a human in an example. FIG. 6 shows a graph for the procedure for facial emotion detection with event cameras. FIG. 6 shows a human face 61, which is recorded using an event camera 62. The optical event data from the event sensor 62 is then analyzed, events with facial feature points are extracted 63. In the facial data 64 an old event 64a is depicted versus a new event 64b (mouth started smiling). In step 65 the facial movement is recognized (detection of emotional pattern). In the emotional analysis 66 it is determined that the corners of the lips are drawn back and up, which is an emotional pattern indicative of the emotional state “Happy” 67. With EVS one can detect sudden changes of expressions, eyebrow movements, pulsating veins or sudden eye motions (a person looks down when they are lying, up when they are recalling).

In further examples, the event cameras or sensors can also be used for human emotion recognition through body gestures. Besides facial expression, the gestures of a body also indicate different emotions of people. With event cameras the human body movement can also be recorded as an assistant for emotion recognition. Nervous motions like unrest in the leg or tics and twitches can be detected to signal uneasiness.

For the potential application fields of examples, firstly, the emotion recognition can be used as an assistant monitor for entertainment systems or interactive gaming. Secondly, a driving assistant monitor may also benefit from driver emotion recognition, to avoid fatigue driving and to recognise extreme emotion (anger, sadness and so on) or signs of sickness (sadness, suffering and so on) to avoid traffic accidents and improve the driving safety. Moreover, human emotion recognition may be helpful for the human machine interaction, since if the robots, e.g., a serving robot, can understand the emotion of owner, they can take actions accordingly, which can improve the satisfaction of users for the robots. In general examples, the adjusting 18 of the service comprises one or more elements of the group of increasing or decreasing an agility of a gaming character, increasing or decreasing a volume of audio, increasing or decreasing a speed of speech or audio content, changing a style of music, adjusting a room temperature, adjusting a brightness and/or color of lighting, offering special effects in the service, adjusting of an avatar of the human, or introducing other humans to the human.

If the whole face of the person moves, one can detect the optical flow of most of the events and subtract it from the scene. This way only parts of the face moving with a different motion (an eyebrow for example) can be segmented out and analysed. Examples may improve the emotion recognition by capturing 12 human facial micro-expressions. Examples may offer affordable and accurate analysis method for emotion recognition. Examples may be implemented with simple setup (event sensor) and might not need high computational cost. Examples may be integrated in many fields to improve the satisfaction of users.

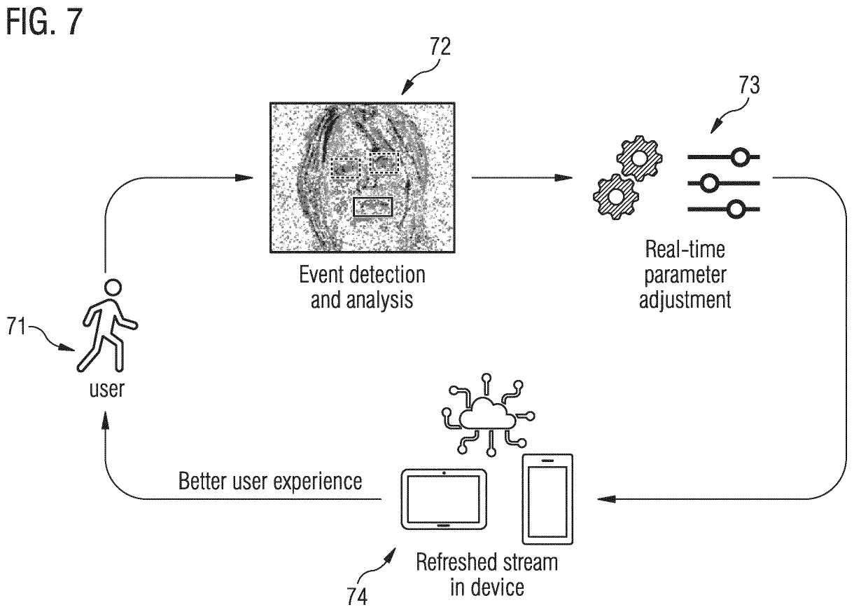

FIG. 7 shows a block diagram of another example of a method for adjusting a service for a human based on the emotional state of the human. FIG. 7 shows a user 71 of which optical event data is captured, optical events are detected and analyzed 72. Based on a determined emotional state of the user real-time parameter adjustment 73 is carried out and a refreshed stream 74 is provide to the user 71 on a user device. FIG. 7 shows a control loop for parameter adjustment on a user's device based on the user's emotional state. An event camera is used for the emotion monitoring loop to allow real-time (or almost real-time) decision making and adjustment. For providing better user experience, the changing or adjustment of device settings should be undetectable from user. Compared with conventional imaging sensors, which capture data frame by frame with exposure time, adjustments can be quicker in the example. With conventional data capturing and transmission, delays on the refreshing of the device according to a new setting may be caused. However, an event sensor has a data stream, which may record data continuously and the transmit data load may be much lower compared to full image transmission. Besides, the event camera can capture the 3D volumes, which contain the time information that can contribute on a better prediction on the facial emotion from user. EVS may allow refreshing within an (almost) undetectable time duration.

If users observe a slowing or paused adjustment for devices (gaming, movie, music, robots . . . ) they may get annoyed by the discontinuity on the stream, and this may decrease the satisfaction of users.

The following table shows parameter adjustments in an example.

| | Emotion | | |
|---|---|---|---|
| Emotion | level | Quantization | |
| Class | estimation | [3 bits] | Parameter examples |
| Happy | 1.0-10.0 | 1-8 | If <3, change to cheerful music. |
| | | | If >3 but <6, increase 10% sound volume. |
| | | | If >6, make no impact of current setting. |
| Sad | 1.0-10.0 | 1-8 | If >1, increase music beats. |
| | | | If >5, release cheerful smell. |
| Mad | 1.0-5.0 | 1-8 | If >1, increase screen brightness. |
| | | | If >3, change to slow music. |
| | | | If >4, pop up setting window. |
| Boring | 1.0-10.0 | 1-8 | If >2, increase the agility/speed of |
| | | | character/avatar. |
| | | | If >4, release flower smell. |
| | | | If >6, increase the sound volume and increase |
| | | | screen brightness. |
| Scared | 1.0-6.0 | 1-8 | If <4, make no impact of current setting. |
| | | | If >4, decrease the brightness and contrast. |
| Cheerful | 1.0-7.0 | 1-8 | If >5, make no impact of current setting. |
| | | | If <5, increase hue of screen. |
| | | | If <3, switch the background picture to a |
| | | | beach or forest. |

The following table shows examples of parameter adjustment in a weighted emotion matrix.

| | Emotion level | | |
|---|---|---|---|
| Emotion | estimation | Weight | |
| class | Vₑₘₒₜᵢₒₙ_{_{—}}ᵢ | Wₑₘₒₜᵢₒₙ_{_{—}}ᵢ | Parameter |
| Happy | 1.0-10.0 | 1 | Calculate the |
| Sad | 1.0-10.0 | −2 | Sum(Vₑₘₒₜᵢₒₙ_{ᵢ} * Wₑₘₒₜᵢₒₙ_{_{—i}}₎) = S_{ₑₘₒ}_{,} |
| Mad | 1.0-5.0 | −1 | i = {happy, sad, mad, boring, scared, cheerful . . . }. |
| Boring | 1.0-10.0 | −3 | If Sₑₘₒ < 0, change the background music, increase |
| Scared | 1.0-6.0 | 2 | the brightness of screen, release cheerful |
| Cheerful | 1.0-7.0 | 3 | smell. |
| | | | If 0 < Sₑₘₒ < 10, increase 10% of music volume, |
| | | | speed up the avatar movement. |
| | | | If 10 < Sₑₘₒ < 20, from time to time give applaud |
| | | | sound. |
| | | | If Sₑₘₒ > 20, keep current setting. |

In examples a facial region may be detected by detecting eyes blinks. Additionally or alternatively, an event-based face detection may be carried out, e.g. using boosted kernelized correlation filters for event-based face detection.

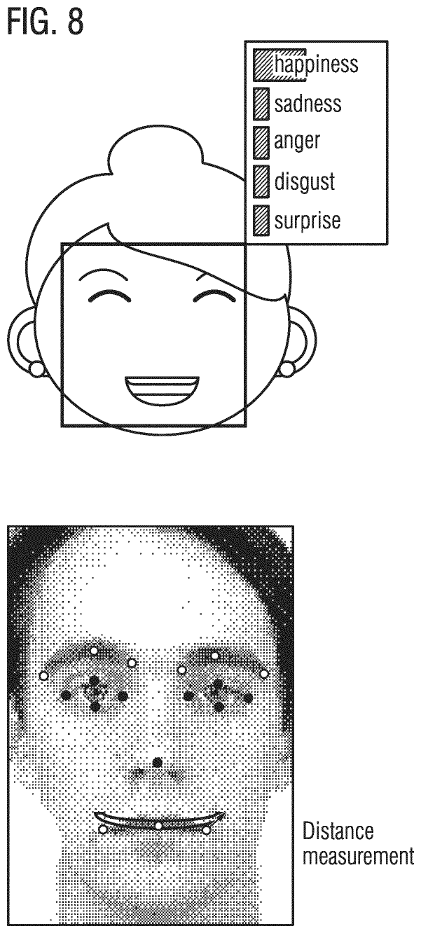

FIG. 8 illustrates detection of an emotional state based on predefined patterns. FIG. 8 illustrates a detected face at the top. After detection of emotional patterns in the face confidence or level information for different emotional states of the user can be determined. These are indicated in the bar diagram, which shows the highest confidence/level for happiness. At the bottom FIG. 8 shows another face, in which relevant key points are illustrated along the eye brows, the eyes, the nose and mouth. For example, a distance measurement between subsequent key points marking the corners of the mouth may indicate, whether the corners have been moved up (smile (happiness)) or down (sadness).

For example, with a positive event rate in the related region a level (confidence) of happiness can be obtained by evaluating a percentage of positive events in a month and eyes region. Determining distances of key points in the face may ease face landmark deformation or face pose alignment detections.

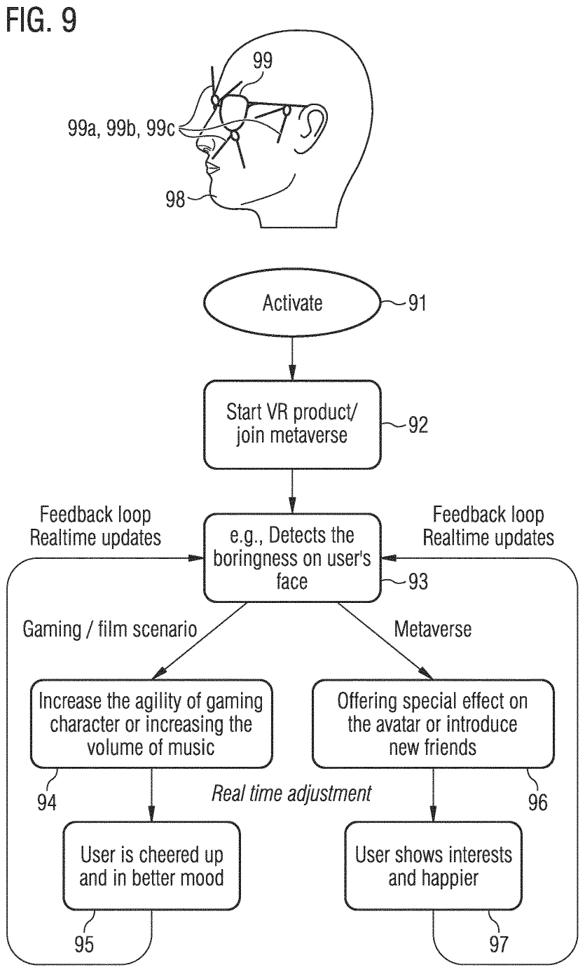

FIG. 9 shows a block diagram of another example of a method for adjusting a service (gaming/film or metaverse) for a human based on the emotional state of the human. The service may be a virtual reality movie or game and the user 98 may wear a virtual reality (VR) device 99 (e.g. glasses) with multiple event-based sensors 99a, 99b, 99c, each with a certain field of view angle. Potentially there may be more than the three sensors shown in FIG. 9. For example, one sensor may be positioned on the corner of a glass and used to detect the movement at the mouth area. Another sensor may be positioned on spectacle frames close to an ear and used to collect the movement at the user's cheek. Another sensor may be positioned toward forehead and yet another sensor may be positioned toward the eyes.

FIG. 9 shows an activation 91 of a service at the top after which the VR product 99 is started 92 or joined into the service/metaverse. The example method detects 93 the boringness on the user's 98 face in line with the above description. In the gaming/film scenario an agility of a gaming character may be increased 94 or a volume of music may be increased 94 based on the level of boringness. The user 98 may then be cheered up and in a better mood 95. The steps 93, 94, and 95 run in a feedback loop for real-time updates or adjustments. In case the service is metaverse, special effects on an avatar may be offered or new friend may be introduced 96. The user 98 may then show interest and be happier 97. The steps 93, 96, and 97 also run in a feedback loop for real-time updates or adjustments.

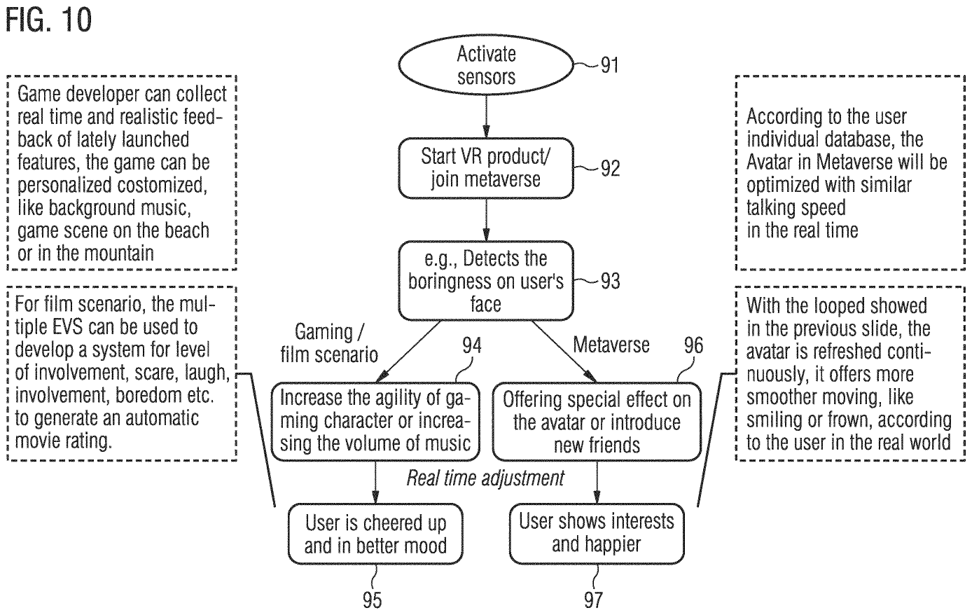

FIG. 10 shows a block diagram of the example of FIG. 9. In FIG. 10 it is further indicated that a game developer can collect real time and realistic feedback of lately launched features, and the game can be personalized or customized, like using background music adjustment, game scene adjustment, e.g. on the beach or in the mountains. For the film/movie scenario, the multiple EVS can be used to develop a system for adjusting a level of involvement, e.g. in terms of scare, laugh, involvement, boredom etc. to generate an automatic movie rating.

Furthermore, in some examples, according to a user individual database, the avatar in the metaverse may be optimized with similar talking speed in real time. With the loops showed in FIG. 9, the avatar can be refreshed continuously, may offer smoother moving, like smiling or frown, according to the user in the real word. The advantage in this example is real-time information collection, instead of the traditional steps: data collection, processing and signal sending. The event stream is continuous, therefore all steps are parallel, all the data collection and parameter adjustment can be done in real-time.

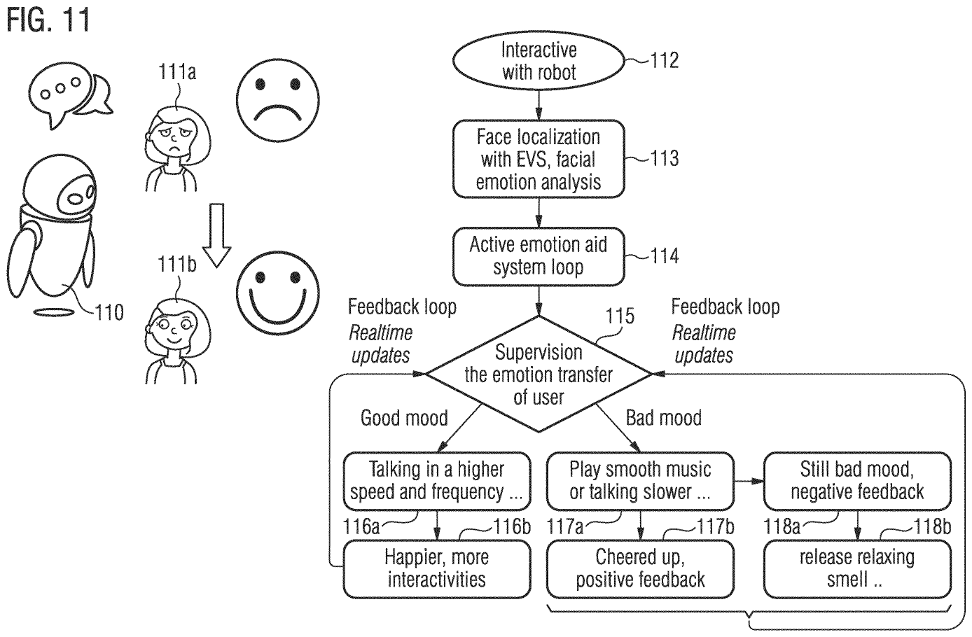

FIG. 11 shows a block diagram of another example of a method for adjusting a robot service for a human based on the emotional state of the human. FIG. 11 shows on the left a robot 110 interacting with a user, which is first shown in a sad emotional state 111a but is then cheered up into a happier emotional state 111b. The according flow chart is shown on the right. It starts with the interaction 112 between the user and the robot. Face localization with EVS and a facial emotion analysis is carried out in step 113. An active emotion and system loop 114 is run as outlined above and the emotion is monitored or supervised in 115. In case the user is in a good mood, a higher speed and frequency can be taken 116a. This may result in the user being happier and more interactivities 116b between the robot and the user. The feedback loop includes steps 115, 116a, and 116b for real-time updates. In case the user is in a bad mood, smooth music can be played or a talking of the robot can be slowed down 117a. If the user cheers up 117b (positive feedback) the feedback loop closes back to step 115. If the user is still in a bad mood (negative feedback) 118a, a relaxing smell is released in 118b.

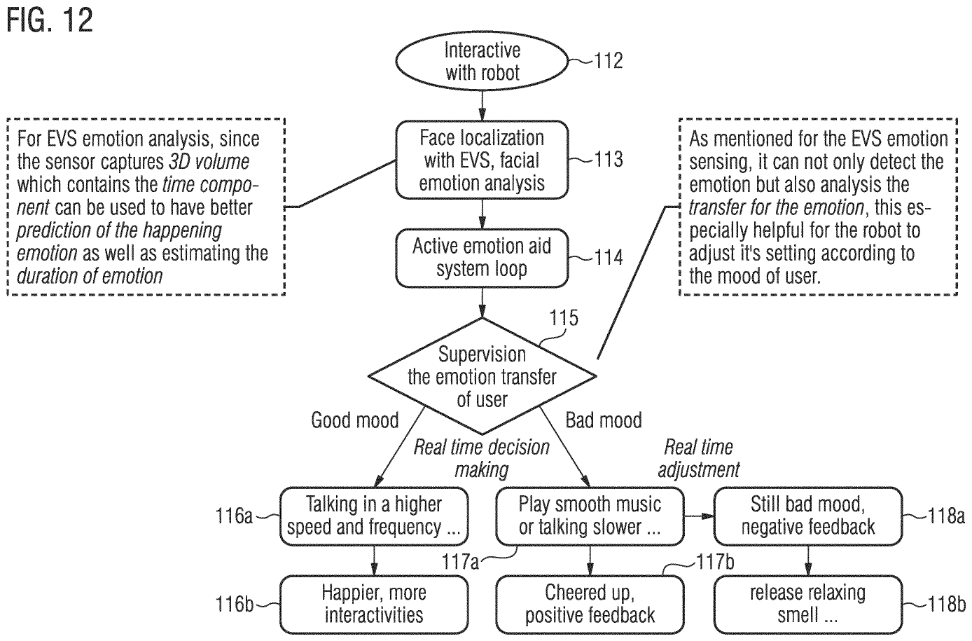

FIG. 12 shows a block diagram of the example method of FIG. 11 with additional information. For EVS emotion analysis, since the sensor captures 3D volume, which contains the time component, the captured information can be used to have better prediction of the happening emotion as well as estimating the duration of emotion. As mentioned for the EVS emotion sensing, it cannot only detect the emotion but also analyzes the transfer for the emotion, this is especially helpful for the robot to adjust its setting according to the mood of user.

In the following some examples are summarized:
(1) A method for adjusting a service consumed by a human, the method comprising capturing optical event data of the human using an event-based sensor; analyzing the optical event data to detect predefined emotional patterns; determining information on an emotional state of the human based on detected emotional patterns in the optical event data; and adjusting the service based on the information on the emotional state of the human.
(2) The method of (1), wherein the service is a game, a movie, a smart home service, or a metaverse.
(3) The method (1) or (2), wherein the capturing comprises capturing optical event data from a plurality of event-based sensors.
(4) The method (1) to (3), wherein the capturing comprises capturing optical event data in 3-dimensional volume comprising a time component.
(5) The method of (1) to (4), wherein the optical event data comprises pixelwise polarity data on brightness or contrast changes.
(6) The method of (1) to (5), wherein the optical event data has a sampling rate of at least 500 frames per second.
(7) The method of (1) to (6), wherein the analyzing comprises determining micro movements in the optical event data to detect the predefined emotional patterns.
(8) The method of (8), wherein the micro movements refer to one or more elements of the group of the human's mouth, eye, eyebrow, eye lid, lip, jaw, skin, cheek and nose.
(9) The method of (1) to (8), wherein the analyzing comprises analyzing a facial expression of the human to detect the emotional state.
(10) The method of (1) to (9), wherein the analyzing comprises analyzing a body posture or gesture of the human to detect the emotional state.
(11) The method of (1) to (10), wherein the adjusting of the service comprises one or more elements of the group of increasing or decreasing an agility of a gaming character, increasing or decreasing a volume of audio, increasing or decreasing a speed of speech or audio content, changing a style of music, adjusting a room temperature, adjusting a brightness and/or color of lighting, offering special effects in the service, adjusting of an avatar of the human, or introducing other humans to the human.
(12) A computer program having a program code for performing a method according to any other example herein, when the computer program is executed on a computer, a processor, or a programmable hardware component.
(13) An apparatus for adjusting a service consumed by a human comprising circuitry configured to perform one of the method of (1) to (11).
(14) The apparatus of (13), further comprising a plurality of event-based optical sensors with different field of views of the user.
(15) The apparatus of (13) or (14), wherein the service is a game, a movie, a smart home service, or a metaverse.
(16) The apparatus (13) to (15), wherein the circuitry is configured to capture optical event data from a plurality of event-based sensors.
(17) The apparatus (13) to (16), wherein the circuitry is configured to capture optical event data in 3-dimensional volume comprising a time component.
(18) The apparatus of (13) to (17), wherein the optical event data comprises pixelwise polarity data on brightness or contrast changes.
(19) The apparatus of (13) to (18), wherein the optical event data has a sampling rate of at least 500 frames per second.
(20) The apparatus of (13) to (19), wherein the circuitry is configured to determine micro movements in the optical event data to detect the predefined emotional patterns.
(21) The apparatus of (20), wherein the micro movements refer to one or more elements of the group of the human's mouth, eye, eyebrow, eye lid, lip, jaw, skin, cheek and nose.
(22) The apparatus of (13) to (21), wherein the circuitry is configured to analyze a facial expression of the human to detect the emotional state.
(23) The apparatus of (13) to (22), wherein the circuitry is configured to analyze a body posture or gesture of the human to detect the emotional state.
(24) The apparatus of (13) to (23), wherein the circuitry is configured to adjust the service by means of one or more elements of the group of increasing or decreasing an agility of a gaming character, increasing or decreasing a volume of audio, increasing or decreasing a speed of speech or audio content, changing a style of music, adjusting a room temperature, adjusting a brightness and/or color of lighting, offering special effects in the service, adjusting of an avatar of the human, or introducing other humans to the human.
(25) A robot comprising the apparatus of (13) to (24).
(26) A vehicle comprising the apparatus of (13) to (24).
(27) An entertainment system comprising the apparatus of (13) to (24).
(28) A smart home system comprising the apparatus of (13) to (24).

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F) PLAs), (field) programmable gate arrays ((F) PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps,-functions,-processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. A method for adjusting a service consumed by a human, the method comprising
capturing optical event data of the human using an event-based sensor;
analyzing the optical event data to detect predefined emotional patterns;
determining information on an emotional state of the human based on detected emotional patterns in the optical event data; and
adjusting the service based on the information on the emotional state of the human.

2. The method of claim 1, wherein the service is a game, a movie, a smart home service, or a metaverse.

3. The method of claim 1, wherein the capturing comprises capturing optical event data from a plurality of event-based sensors.

4. The method of claim 1, wherein the capturing comprises capturing optical event data in 3-dimensional volume comprising a time component.

5. The method of claim 1, wherein the optical event data comprises pixelwise polarity data on brightness or contrast changes.

6. The method of claim 1, wherein the optical event data has a sampling rate of at least 500 frames per second.

7. The method of claim 1, wherein the analyzing comprises determining micro movements in the optical event data to detect the predefined emotional patterns.

8. The method of claim 7, wherein the micro movements refer to one or more elements of the group of the human's mouth, eye, eyebrow, eye lid, lip, jaw, skin, cheek and nose.

9. The method of claim 1, wherein the analyzing comprises analyzing a facial expression of the human to detect the emotional state.

10. The method of claim 1, wherein the analyzing comprises analyzing a body posture or gesture of the human to detect the emotional state.

11. The method of claim 1, wherein the adjusting of the service comprises one or more elements of the group of
increasing or decreasing an agility of a gaming character,
increasing or decreasing a volume of audio,
increasing or decreasing a speed of speech or audio content,
changing a style of music,
adjusting a room temperature,
adjusting a brightness and/or color of lighting,
offering special effects in the service,
adjusting of an avatar of the human, or
introducing other humans to the human.

12. A computer program having a program code for performing a method according to claim 1, when the computer program is executed on a computer, a processor, or a programmable hardware component.

13. An apparatus for adjusting a service consumed by a human comprising circuitry configured to perform the method of claim 1.

14. The apparatus of claim 13, further comprising a plurality of event-based optical sensors with different field of views of the user.

15. A robot comprising the apparatus of claim 12.

16. A vehicle comprising the apparatus of claim 12.

17. An entertainment system comprising the apparatus of claim 12.

18. A smart home system comprising the apparatus of claim 12.
